(19) United States
(12) Patent Application Publication
(10) Pub. No.: US 2014/0249966 A1
(43) Pub. Date: Sep. 4, 2014

(54) System and Method for Recipe, Grocery, and Food Services

(71) Applicant: FoodRocket, Inc., San Francisco, CA (US)

(72) Inventors: V. Paul Zaragoza, New York, NY (US); Mark Lucas Sainz Zaragoza, San Francisco, CA (US)

(73) Assignee: FoodRocket, Inc., San Francisco, CA (US)

(21) Appl. No.: 14/015,361

(22) Filed: Aug. 30, 2013

Related U.S. Application Data
(60) Provisional application No. 61/694,995, filed on Aug. 30, 2012.
(60) Provisional application No. 61/820,970, filed on May 8, 2013.

(51) Int. Cl. G06Q 30/06

(52) U.S. Cl. CPC G06Q 30/0635
USPC 705/26.81

(57) ABSTRACT

A system includes one or more software programs which are utilized to automate a process of converting an object in media, such as a recipe on a website, into a component list, such as a recipe list. The component list may be converted to a shopping items list, such as a grocery list. In one example, a recipe website provides recipes. A user selects one or more of the recipes. Software creates a recipe list of recipe items. In one example, this is accomplished by the software reading a recipe presented in the media content. The software automatically converts the one or more selected recipes into one or more shopping lists. The shopping lists may be used by the user to manually obtain and purchase items at a store. Alternatively, the one or more shopping lists may be used as input for an electronic shopping service or a suppliers fulfillment platform.

### CLAIM OF PRIORITY AND CROSS-REFERENCE TO RELATED APPLICATION

The present application is related to U.S. Provisional Patent Application No. 61/694,995, filed Aug. 30, 2012, entitled “System and Method for Recipe, Grocery and Food Services,” and to U.S. Provisional Patent Application No. 61/820,970, filed May 8, 2012, entitled “System and Method for Recipe, Grocery and Food Services.” The present application hereby claims priority under 35 U.S.C. §119(e) to U.S. Provisional Patent Application No. 61/694,995 and to U.S. Provisional Patent Application No. 61/820,970.

### FIELD

The invention relates generally to systems and methods for converting websites with unstructured content into E-commerce platforms. In one example, in connection with food and grocery services, the invention relates to systems and methods for converting recipes into grocery lists and fulfillment orders.

### BACKGROUND

Websites have content which is often in an unstructured format. Websites, blogs, Internet sites, web pages, and the like may have content related to any number of given industries or topics. Sometimes, the content displayed consists of items, systems, objects, and so forth, which are comprised of a number of different components.

E-commerce sites are generally known. E-commerce generally involves the buying or selling of goods and services via the Internet. In a typical E-commerce environment, a user is presented with a plurality of items, which can be displayed in the context of text and/or images. The user selects items by, for example, clicking on the items. A link to a fulfillment platform converts the user's indication of his or her desire to purchase the displayed item into an order. After confirmation of the order and payment for the transaction, the order is fulfilled and delivered to the user. If the item is capable of being delivered electronically, the item may be delivered to the user's station (e.g., computer) via the Internet.

Online grocery shopping is generally known. Web-based services provide for creating a grocery list, submitting the list, and having a grocery service secure and deliver the items on the list. It is also generally known to manually create, and/or add to, a grocery list, based on food items mentioned in a recipe. Online recipe management services currently exist. Such services provide, for example, searching, storing, and categorizing services for those that wish to manage their recipes online. Food websites include recipe sites, online grocery services, restaurant sites, critiquing sites, blogs, forums, and the like.

### SUMMARY

In general, various embodiments provide systems and methods for providing enhanced recipe management and grocery shopping services. A significant proportion of food-themed web usage relates to the search for cooking inspiration (e.g., recipes). Currently, thousands of recipe sites, blogs, forums, review sites, and E-commerce food merchants currently exist, in part, to service consumers' needs to access inspiration and product related information, and to share experiences with products. Yet, to date, no commercially viable technology exists which allows people who search for recipes the ability to instantly and seamlessly purchase their desired ingredients and additional cooking items.

In one example embodiment, one or more software programs are utilized to automate the process of converting a recipe into a grocery list. According to one aspect, a recipe website provides recipes. A user selects one or more of the recipes. The software automatically converts the one or more selected recipes into one or more grocery lists. The grocery lists may be used by the user to manually obtain and purchase items at a grocery store. Alternatively, the one or more grocery lists may be used as input for an electronic shopping service.

Other features may be included. For example, a plurality of lists may be generated with grocery items based on type of item and/or type of store at which the items might be purchased. For example, a recipe might call for fish, clams, spices, tomatoes and other items. One grocery list might include the fish and clams based on a likelihood that one would go to a fish market for those items. Another list might include spices and tomatoes anticipating that a user would go to a regular chain grocery store for those items.

Ontology is another aspect of various embodiments. Ontology herein means performing one or more functions based on a relationship of something (e.g., a step, a function, a data point, a food item, etc.) to a particular environment. For example, according to one aspect, the system might provide information regarding food items, other recipes, and so on that might go well with the one or more selected recipes. Thus, the system might suggest, for example, side dishes, beverages (beer, wine, alcohol, non-alcoholic, natural, sparkling water, still water, combinations, sodas, etc.), and/or eating environments (indoor, outdoor, weather, time of day, time of year, temperature, lighting, seating, tableware, etc.). The system might also provide recipes and grocery lists for any of these items. Also, the system may provide suggestions as to what type/brand of a particular item might be preferable based on the other items/brands or based on the other recipes for a meal.

According to another aspect, the system may suggest cooking equipment, serving pieces, tableware, glassware, napkins, décor, and the like based on one or more selected recipes or based on one or more criteria associated with the one or more selected recipes. For example, if a fish recipe for two is selected, the system may suggest a white wine, wine bucket, and candlelight.

According to another aspect, the system may suggest other recipes based on the one or more recipes selected by the user. According to a related aspect the system may suggest accompaniments (wine, sides, bread, etc.).

In another embodiment, one or more shopping lists are generated. One or more items are added to the list(s) based on a sponsorship factor. The sponsorship factor relates to a concept of providing certain food companies with preferential treatment based on any number of suitable factors including payments, advertising, preferential business arrangements, and the like. For example, if ABC Co. buys advertising time and or space on a website, and if a recipe calls for flour, then the system may be configured to add ABC Brand Flour to the list(s).

According to another embodiment, the system is online and web-based. A web browser extension may be provided. The extension is an app (or application). The app provides a user with the ability to identify a link to a recipe within media content on the Internet. The recipe and/or items from the recipe may be identified and incorporated into the other system functionality described herein. Thus, for example, a user might be reading an article about cooking salmon. The user may be able to scroll over the word salmon and link to one or more salmon recipes. The user may be able to select one or more of the salmon recipes. The selected recipe(s) may be incorporated into the recipe conversion and grocery list generation processes described herein.

Other aspects may be included. For example, the system may provide anticipated ancillary data associated with the one or more lists. This data can include and associated information such as, for example, prices, price comparisons, calorie information, vitamin and mineral information, other health related information, brand and/store comparison information, etc.). Location based services may also be incorporated. Thus, store locations, store distances, maps, and the like may be provided based on the lists generated. Also, the system may be configured to modify the lists based on preferences supplied by the user. These preferences may include store preferences (certain store names, locations, local, national, chain, mom-and-pop, distances, etc.). List creation may also be based, at least in part, on the number of stores anticipated as required to obtain all the listed items. For example, the list may be created with a goal to minimize the number of stores a user must go to get the listed items. A user might be able to enter a maximum number of shopping destinations, distances, price and so forth. Sponsoring stores and/or brands may get preferential treatment in connection with this and other functionalities described herein. Coupons, social and electronic coupons, and the like may also be incorporated. Thus, a list might be generated based on a recipe, but a particular brand of a food item finds its way onto the list based on the availability of a Groupon™ for that item.

In at least one example embodiment, the system and its functionality are provided in connection with an electronic environment. Thus, for example, the system may include a host platform adapted to be connected to one or more user stations and operable to send receive electronic information. The host platform includes one or more computers operable to execute one or more software modules. The host platform further includes one or more databases electronically connected to the one or more computers. A first software module is operable to provide a user with one or more recipes. The module is adapted to recognize the selection of one or more recipes, by the user, from those provided to the user. A software module converts the selected one or more recipes to one or more shopping lists including at least some of the items necessary for the one or more selected recipes.

It should be recognized that the example functionality described herein has applications in industries other than the food industry. For example, the systems and methods described herein may be used to convert content of virtually any subject matter into a listing that may be purchased from an online inventory source. In one example, a home improvement project such as a deck might be described on a website. The website might have an image of the deck, a parts list, plans, and/or needed tools for installing the deck. The inventive systems and methods provide for conversion of these objects into shopping lists. The inventive systems and methods may present inventory based on the subject, from which the user can select and purchase items. One or more algorithms may be used to match the content to one or more product catalogs for fulfillment. Preferably, the system is able to read, or otherwise recognize, web content in any form, such as texts or images. The system understands what object is being illustrated by the text or image and is also capable of breaking the object down into its components (if applicable). For example, the system may recognize an image as a representation of a single product, such as a particular bicycle. The system converts that image into a digital request for that object and matches that request with a vendor based on any number of factors including price, advertising priority, availability, geography, user preferences, time-of-year, holidays, delivery methods, and the like. Alternatively the system breaks the object down into components and matches those components with one or more suppliers. The suppliers, providers, vendors, etc. may be online entities that provide their products in the context of an E-commerce environment. Or, they may be brick-and-mortar providers that can assemble an order and deliver it to the user or make it available for pickup by the user.

In at least some embodiments, the system also accommodates user preferences relating to brands, quantities, quality, availability, payment methods, delivery methods, delivery times, and the like.

In one example embodiment, a fulfillment system includes an object recognition module adapted to recognize an object within content on a media display. A component set creation module is also provided and is adapted to convert the object into a component set of one or more components of the object. A conversion module is also provided and is adapted to convert the component set into an order request for ordering the one or more components of the component set. The order request has one or more order items corresponding to one or more of the one or more components of the component set. A supplier matching module is also provided and is adapted to match the order for matching the one or more order items of the order request with a supply source having at least one of the one or more order items.

In another example embodiment, a culinary management system includes a host platform adapted to be connected to one or more user stations and operable to send and receive electronic information. The host platform includes one or more computers operable to execute one or more software modules. The host platform further includes one or more databases electronically connected to the one or more computers. A first software module is operable to receive a user's selection of one or more recipes from among a plurality of recipes presented to the user. A second software module is operable to transform information associated with the selected one or more recipes into a shopping list comprising one or more ingredients of the one or more selected recipes.

In another example embodiment a method of generating an order from media content is provided. In one step, the method includes identifying the media content. In another step, the method includes identifying an object within the media content. In another step, the method includes converting the object into a component list of components of the object. In another step, the method includes generating a shopping items list having at least one shopping item corresponding to at least one component of the component list.

### BRIEF DESCRIPTION OF THE DRAWINGS

For a more complete understanding of this disclosure and its features, reference is now made to the following description, taken in conjunction with the accompanying drawings, in which:

FIG. 1 is a block diagram of system for managing recipe and shopping list information in accordance with an example embodiment;

FIG. 2 is a graphical user interface providing a user environment in accordance with an example embodiment;

FIG. 3 is a graphical user interface providing a management display in accordance with an example embodiment;

FIG. 4 is a graphical user interface providing shopping list generation in accordance with an example embodiment;

FIG. 5 is a graphical user interface providing a scheduling matrix in accordance with an example embodiment;

FIG. 6 is a graphical user interface providing order processing in accordance with an example embodiment;

FIG. 7 is a block diagram of an architecture for providing recipe and shopping list functionality in accordance with an example embodiment; and

FIG. 8 is a flow chart showing a method for managing recipe and shopping list information in accordance with an example embodiment;

### DETAILED DESCRIPTION

According to various embodiments, a system is provided for enabling users to manage and manipulate recipe and shopping list information. The system includes a number of different hardware, software, and networking components to enable the various functionalities associated with managing and manipulating the information.

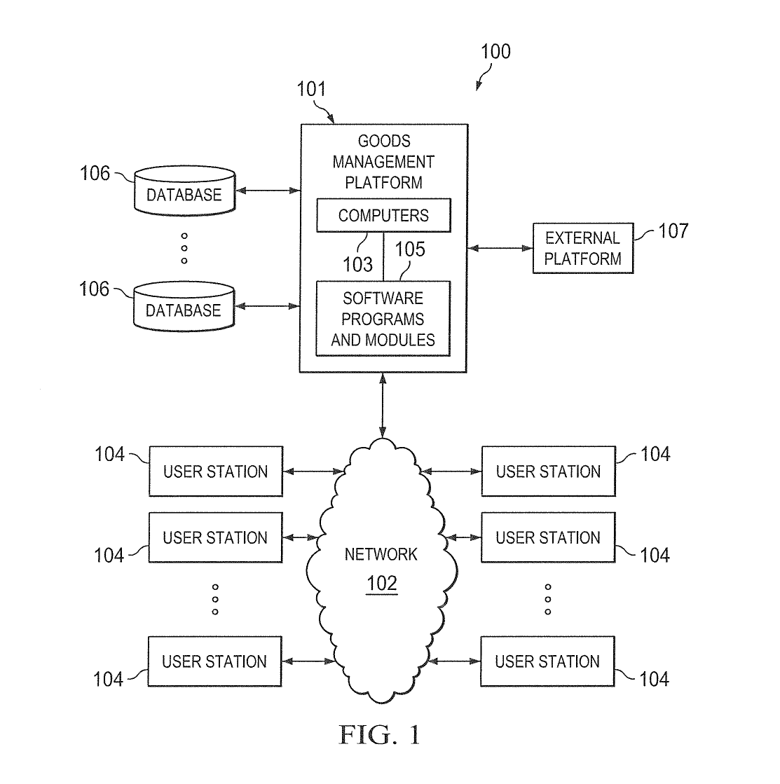

As shown in FIG. 1, for example, a system 100 is provided for managing recipe and shopping list information. System 100 includes a number of different components, which will be described in further detail. One or more of the components may comprise hardware and/or software. The components are operable to communicate with one another. The communication between components may be conducted over any suitable existing, or future, telecommunication path employing any suitable existing, or future, telecommunication technology. For example, telecommunication may occur over one or more communication networks employing one or more technologies such as wide area networks, local area networks, virtual private networks, metropolitan area networks, etc. The communication may employ any suitable protocol including, without limitation, transmission control protocol, internet protocol, hypertext transfer protocol, file transfer protocol, and the like. Other technologies may be employed such as Wi-Fi, Bluetooth, cloud computing, etc. The communications may employ cellular, wireless, land lines, cloud computing and other technologies. Information may be transferred using any known switching and data transfer technologies.

System 100 includes a goods management platform 101. System 100 also includes one or more user stations 104 connected to goods management platform 101. The connection may be accomplished via a network 102. It should be understood that the connection between components may be according to any suitable known or future connection involving networking, telecommunications, data transmission, and the like. It should also be understood that various embodiments may include multiple user stations, computers, servers, databases, processors, and other components interconnected according to any suitable configuration that allows the functionality of the system to be executed.

User station 104 can be any type of suitable user device that provides connectivity to network 102 and the platform 101. Thus, user station 104 can be a computer, server, Internet-enabled device, television, smart book, notebook, laptop, desktop, smartphone, telephone, mobile phone, kiosk, interactive device, handheld device, etc. Platform 101 may comprise any suitable computer such as, but not limited to, computers, personal computers, desktops, laptops, notebooks, smart books, servers, and the like.

Platform 101 comprises one or more computers 103 capable of executing various software programs and modules 105. Platform 101 may also be coupled to one or more databases 106 for storing information associated with the services it provides. Platform 101 may also be connected to one or more external platforms 107. It should be understood that FIG. 1 represents an example architecture, and the various components may be configured in any suitable manner. Also, various components may be added or deleted as appropriate to achieve the various functionalities described herein. Moreover, certain components may be included in other components, and certain sub-components shown as part of a particular component may be configured such they are external to the particular component. For example, databases 106 may be included within platform 101. Modules 105, for example, may be included in computers that are external to, and coupled to, platform 101.

The computers incorporated into system 100 may include any suitable type and the term “computer” is not intended to be limiting as to any particular type of computing platform or processor. Similarly, any suitable databases may be employed and the term “database” is not intended to be limiting as to any particular type of database. The one or more computers and databases may be linked together in any suitable manner using any known, or future, computer networking technology. Other components within system 100 may also comprise one or more computers and databases and those components may likewise use any suitable computers and databases that are connected using any known, or future, networking technology.

User stations 104 are operable to contact the one or more computers 103 in platform 101 to request information associated with the information needed to achieve the functionality described herein. Computers 103 may, in turn, retrieve the requested account information from, for example the one or more databases 106. Computers 103 may similarly request, accept, and/or retrieve information from users through user stations 104 and from other third-party platforms such as, for example, external Internet websites (not expressly shown, but which could be included within sub-platform(s) 107). [Sub platform may be advertising, linking with vendors

Platform 101 may determine a variety of information associated with identified users and third-party sources. This information may include, without limitation, one or more names, identification numbers, passwords, account identity information, account balance, account availability, other accounts linked to the particular account, and any other information such as account holds, fraud alerts, etc. One or more modules 105 enable the operation of the various system functionalities.

At least one of the modules is operable to receive information from a third-party source. This module may comprise an ftp (file transfer protocol) module or any other suitable component for receiving data from a data source. The data provider may be an independent or third-party data provider that provides data relevant to the activity on which the system functionality is based. Other modules may provide other functionality as described herein. For example, in a product fulfillment context, one of the modules may be a content acquisition module. This module accesses and/or acquires content in a media environment (e.g., on the Internet). Acquisition may be accomplished in any suitable manner. In at least one embodiment, acquisition may be accomplished by way of identification of key words, phrases, images, icons, numbers, and the like. In alternative examples, acquisition is accomplished by way of metadata, links, flags, embedded information, spatial recognition, position within the media environment, predetermined formatting, and the like. Another module may be an object recognition module for recognizing a specific object within the content (e.g., a subject, such as a food dish). The object recognition module may accomplish object recognition in any suitable manner including, without limitation, those mechanisms used for content acquisition. A conversion module may be provided to convert an object into a request. This may involve a number of steps such as converting the object into a component list, providing a shopping or order list to correspond to the component list (or to parts of the component list), enabling a user to modify the shopping or order list, and enabling the user to complete order information. A vendor matching module may be provided to match an order request to one or more supply sources (e.g., suppliers, stores, vendors), which may fill the order. A fulfillment module may be provided for enabling a user to order the object (or one or more of its components) and receive delivery of the object or component(s). It should be recognized that these are example modules only. More or fewer modules may be provided. Various functionality, including functionality described elsewhere herein may exist in various modules, in different modules, in multiple modules, or in other system and/or external components. The functionality may be grouped differently into the various modules. The names of the modules are examples, and may be changed while the module itself provides the same or modified functionality. It should be understood that references to a first software module and a second software module, for example, do not necessarily mean that the two pieces of software are, in fact, separate or found in separate components. Both modules may be in a single component, and both modules may be part of the same software program. Moreover, a single piece of software may include both the first and second software “modules.” Thus, in certain embodiments, “module” merely relates to one or more certain functionalities of the software.

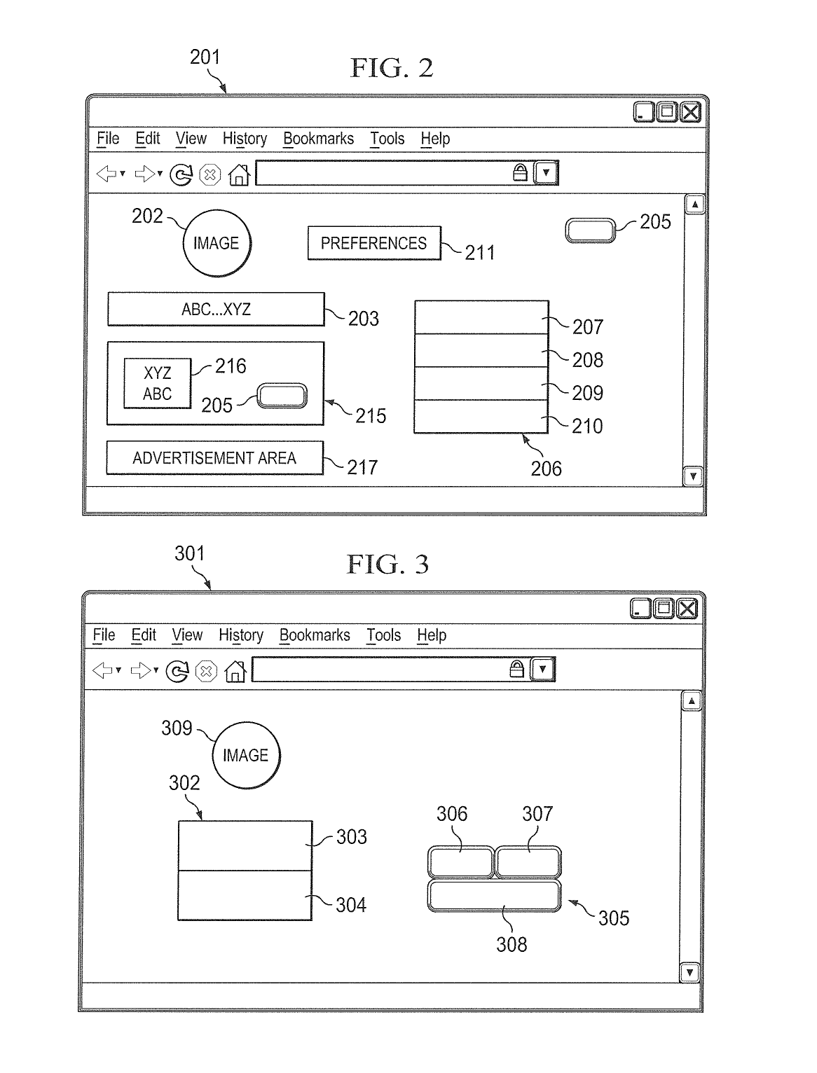

FIG. 2 illustrates a user environment, which may be manifested in any suitable display or medium. For example, the user environment might exist as a graphic user interface displayed on a page of a web site. Alternatively, the user environment may be in the context of an application on a computer, tablet, smartphone, etc. Other user environments may be incorporated and used to provide the functionality described herein. As illustrated, for example, display 201 is a page on a website, which may be accessed by a user. The user may access the page by visiting the website directly, by linking to the website from another site, or from another application, by being redirected to the website, or by another suitable set of actions. Display 201 includes one or more images 202. Image 202 may be a photo, drawing, or the like. For example, image 202 may be a photo of a particular food dish. In other contexts, image 202 may be a photo of any other product, which the system will recognize, and for which the system will complete a listing of parts, items, sub-items, etc., which may then be fulfilled by a fulfillment application, module, or platform.

One or more subject titles 203 are also provided. In this example, subject title 203 is a textual representation of the subject displayed in picture 202. Specifically, in this example, subject title 203 is a textual name of the food dish displayed in image 202. For instance, if the food dish displayed in image 202 is a photograph of citrus-Dijon wild salmon, then subject title 203 may be a text box, for example, with the words “citrus-Dijon wild salmon.” It should be recognized that multiple subject titles may be provided for one associated image or subject detail box (described below). Alternatively, there may be multiple subject titles, but only one each for multiple images and/or subject detail boxes. Other configurations and relationships between these items may be incorporated.

A subject detail box 215 is also provided as part of display 201. Subject detail box 215 may have a component listing box 216 and an order initiation button 205. Subject detail box 215 may have other information (not expressly shown) about the subject, or subjects, being represented, for example, on the particular page of the website (e.g., on display 201). Subject detail box 215 may have information on other subjects, the content of which is located elsewhere. Subject detail box 215 may also have other buttons that allow initiation of other actions by a user. In at least some embodiments, subject detail box 215 displays information about components of a subject. The subject may be that which is displayed or represented in, for example, image 202 and/or subject title 203.

In the illustrated example, component listing box 216 displays the components of a recipe for the dish represented in image 202 and subject title 203. Instructions on assembling the components (in this case, instructions for preparing the food dish) may also be provided. As described further elsewhere, components within component listing box 216 may be segregated or grouped according to one or more criteria. The criteria may be associated with user preferences, for example.

In at least one embodiment, the segregation of components is based on whether the component is considered a staple or a non-staple item. A staple item would be that which is common to many related subjects within a domain. For example, in the food domain, a staple item would be an item common in many food dishes (food dishes being related items in the food domain). In this specific example, staple items might consist of butter, oil, salt, pepper, and the like. Non-staple items would be those items that are specific to the particular subject being represented. For example, in the case of citrus-Dijon wild salmon, a salmon filet would be a non-staple item. The determination of whether a component is staple or non-staple may be made by an algorithm, module, or some other application, which identifies the component (or receives an identification of the component), compares the identification to data (e.g., other identical items or similar items), and classifies the component as staple or non-staple. Alternatively, the determination may be made by a user, a vendor, a content provider, a web host, a system operator, or some other person or people. In either event, metadata associated with the component may include information regarding whether the component is considered staple or non-staple. Further, the determination may be made in advance of enabling users to access the information, or contemporaneously with user activity. In certain cases, the determination of whether an item is staple or non-staple may be based on other factors, such as a user purchasing history. For instance, if a user has always purchased butter in prior orders, then butter may be determined as a non-staple item for that particular user (where it would otherwise normally be consider a staple item).

A user may click on order initiation button 205 to start a process for preparing a shopping list and/or ordering one or more of the components listed in the component listing box. Clicking the order initiation button may start any number of associated actions. In some embodiments, clicking the order initiation button immediately takes the user to a checkout environment. In other embodiments, the user may be taken to a component listing environment. In other embodiments, the user may be taken to a purchasing environment where the user may make selections of components and set up a shopping list. The shopping list may then be converted to an order by interfacing with a fulfillment platform (e.g., a grocery store fulfillment platform). It should be understood that multiple order initiation buttons 205 may be provided at different locations within the display. For instance, as illustrated, the display includes two order initiation buttons 205.

Image 202, subject title 203, and subject detail box 216 (and other items on display 201) may be provided in any suitable format including, for example, jpeg. These items may have associated metadata and/or other supporting data specifying information about the item, information about other content associated with the item, information about the subject of the item, linking information to other media and data, and the like. These items may be “clickable.” That is, a user may click on the item (e.g., image 202) (e.g., by using a mouse or some other indicator), in order to initiate an action. The action may be any of the functionality described herein that is suitable for initiation by clicking on the item.

It should also be recognized that although the descriptions herein of the various displays, for example, use terms such as “box,” “button,” “image,” “text” and the like, the form of the particular item may be altered as suitable and/or as desired. These are example terms only and are used to provide context for the various items and, in certain cases to clarify functionality. The terms are not intended to be limiting as to form, function, appearance, and the like.

Display 201 includes other items. For example, a preferences box 211 may be provided. Preferences box 211 may have selectable preferences or may link to a page or popup window (or some other display) where preference options are displayed. Preferences can include user preferences relating to the shopping experience, the web site experience, the ordering experience, or any other aspect of the functionality described herein where user preferences are suitable. With respect to shopping and ordering preferences, for example, the preferences may be based on or relate to costs of individual items, costs of all items for a particular subject (e.g., total cost of a food dish), store types, store locations, brands, number of stores required to fulfill an order, preferred user accounts, rewards accounts, allergies, brands or items the user will never purchase, brands or items within the components that would cause a user to refrain from purchasing any components associated with the subject, and the like.

Display 201 also includes an ontology box 206. Ontology box 206 includes a number of ontology modules 207, 208, 209, and 210. The various ontology modules enable a user to access data, and conduct actions, associated with or related to the subject(s) or domain represented by the display. For example, ontology module 207 provides a user access to other subjects (e.g., recipes). In the specific example, ontology module 207 provides a user with access to other recipes (and images, component listings, ordering processes, and so forth) that are related to the citrus-Dijon wild salmon that the user was working with. As another example, ontology module 208 provides the user with access to information concerning suggested environments for partaking of the subject(s) otherwise represented. For instance, accessing ontology module 208 in the spring might return a suggestion of eating the dish outdoors in the evening beside a fireplace. Other related component lists might be provided related to the suggested environments (or to any of the other ontologies or data associated with other ontology modules). Other related components for the particular example environment might be long matches, firewood, disposable tablecloth, outdoor utensils, plastic stemware, candles, decorative lights, portable mp3 player, and the like). As another example of the ontology box, an ontology module 209 provides a user access to information, component lists, order processing and so forth concerning tableware (e.g., utensils, serving ware, glassware, dishes, bowls, napkins, napkin rings, center pieces, and the like). As another example, ontology module 210 provides a user with access to information, component lists, order processing and so forth for beverages relating to the subject dish.

The ontology box, or any of its modules, may be configured to provide a user with a variety of information, component lists, order processing and so forth based on any number of factors including, without limitation, the user preferences described elsewhere herein, other user factors (e.g., age, sex, income), time of day, time of year, weather, location of use of the subject (e.g., eating indoors or out), user history, guest information, and the like.

As illustrated, display 201 also includes an advertisement area 217. Advertisement area 217 provides users with advertisement information. The advertisements may be provided by the system host, the user, or by any third party, such as vendors, suppliers, and the like. There may be multiple advertisement areas. Advertisements may be in any format. Other similar information (e.g., blogs, comments, and social media processes) may be provided in the advertisement area or in other available display real estate. Advertisement space, such as area 217 may be provided on any of the displays, web pages, interfaces, and the like described herein. Information may be targeted, and based on any suitable information or data. For example, advertisement may be based on data (age, income, location, sex, religion, interests, other sites visited, travel preferences, spending habits, etc.) about the user, which may be collected from the user's use of the system or from a third-party vendor of user data, for example. Targeted advertising may also be based on user actions within the system (e.g., selection of an item, activating a process, visiting a web page, time spent on a web page, etc.).

FIG. 3 illustrates a component management web page. In some embodiments a user may be directed to a display such as this in order to further manage a component listing for a subject (e.g., recipe for a food dish), and refine the process of initiating shopping lists and orders. In certain embodiments, all of this information and functionality may be either bypassed, included within one or more other interfaces on one or more other displays (e.g., other web pages), or provided in one or more interfaces of a different format (e.g., within a pop up window from another web page). As such, the particular architecture and functionality associated with this web page, as well as the other web pages, interfaces, and displays illustrated and described herein, is for example purposes only.

In this particular example, if a user selects a subject item, such as a food dish, from the web page illustrated in FIG. 2, for example, the user might be directed to this web page by way of a link. As illustrated in FIG. 3, a management display 301 includes a component listing box 302, which lists the components of the subject as previously described. For instance, a recipe for a food dish may be provided here. In this embodiment, component listing box 302 is divided into one or more sections based on groupings of the respective components. For example, in the case of food, a non-staple items sub-box 303 may be provided to indicate recipe items that are non-staple. A staple items sub-box 304 may also be provided to indicate recipe items that are considered staples. Other groupings can exist. For example, groupings may be based on heart-healthy items, items according to food group, items according to standard product placement within a store, items available in a particular store, items according to food type (e.g., spices, frozen foods, dairy, etc.), items that may cause allergies, and so forth.

Management display 301 may also provide one or more images 309 associated with the respective subject item, as previously described. As illustrated, management display 301 provides an order initiation button 305. Button 305 functions largely as previously described in connection with the order initiation button shown in FIG. 2, for example. However, this particular order initiation button is somewhat more robust. For example, this button includes various sub-buttons which refine the order initiation process. Sub-button 306, for example, may be clicked by a user to start the process with respect to only non-staple items. Sub-button 307, for example, may be clicked by a user to start the process for only staple items. Sub-button 308, for example, may be clicked by a user to start the process for both staple and non-staple items. Other sub-buttons may be provided to either add certain component groupings to the order initiation process and/or to bar certain groupings for the process. Also, it should be understood that this functionality may be provided in any other suitable way. For example, the component listing box (and sub-boxes) may be configured in a drag and drop manner so that items may be removed, added, moved between groupings, and so forth.

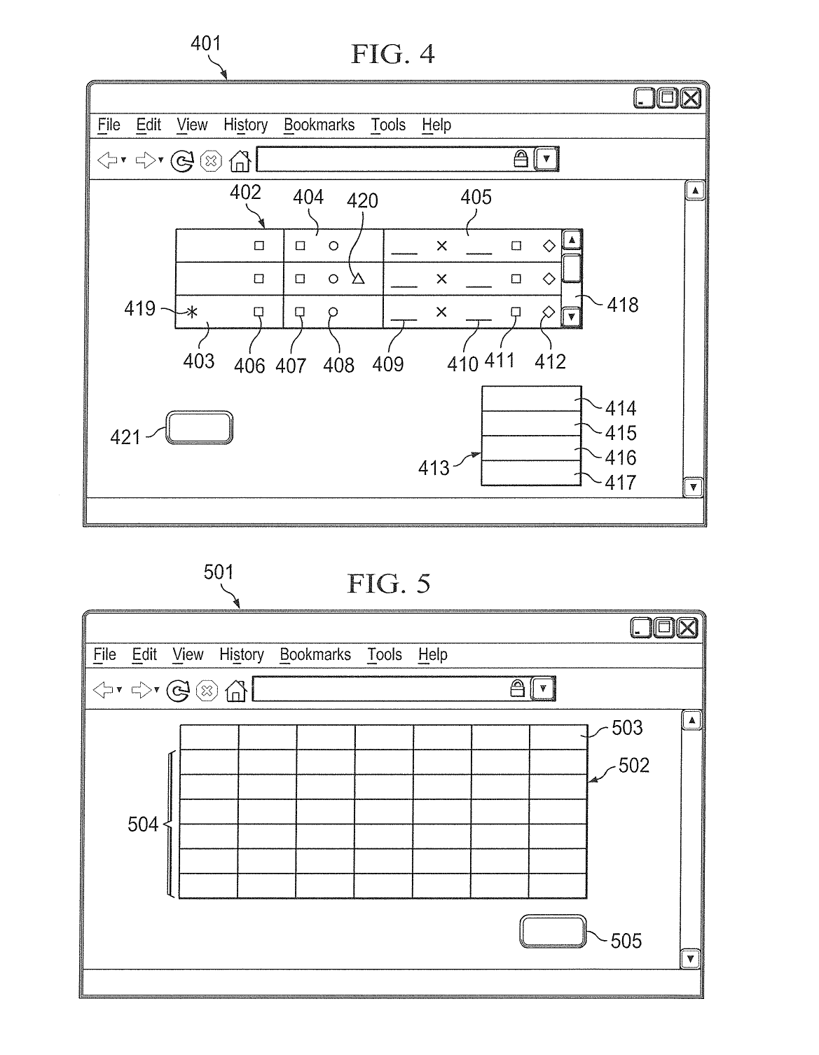

FIG. 4 illustrates a shopping list generation web page. Shopping list display 401 provides a variety of functionality for converting a component listing into a list of items to be purchased, shipped, fulfilled, or otherwise obtained, for example, by the user. Display 401 includes an order grid 402 having a plurality of rows and columns representing information about particular components from a component listing (e.g., a food recipe). Each row in order grid 402 corresponds to a particular component. The columns correspond to various types of information about the particular component. It should be understood that the grid is simply an example of the information being displayed. Other types of configurations may be incorporated. Even within a grid structure, the columns and rows may be reversed. That is, each column can represent a component, while the rows have different information about the particular component. Also, FIG. 4 illustrates three rows representing three components. It should be understood that more or fewer than three components may be represented. Further, a mechanism, such as scroll bar 418, may be provided to view additional rows (or columns) of information.

In this example, each row has a component listing description 403, a shopping item description 404, and an order box 405. The component listing description may include any suitable number of different pieces of information to describe the component in the context of the component listing. That is components are described in a manner as specified by the content provider of the subject description or as interpreted by the system. The description is of the component, as it is a part of a subject item. For instance, in terms of a recipe for citrus-Dijon wild salmon, the component description for salmon might be “1 small salmon filet.” This might be a different description than the corresponding shopping item description for the salmon component. In the illustrated example, there is a component description text box 406. Other information may be provided such as images, video, etc. Also illustrated in the component listing description is an indicator 419 for whether or not the component is a staple or non-staple item. Other indicators may be provided for other classifications or groups of components. It should also be understood that the components on the shopping list may be automatically grouped according to classification. For example, all the non-staple items may be provided in the first rows from top to bottom, while all the staple items are displayed in the bottom rows. Different color schemes may also be used to distinguish between any of the different types of information described herein. For example, non-staple items might be displayed in green rows, while staple items are displayed in red rows.

Shopping item description 404 provides a description of the component in the context of a corresponding item to be found at or supplied by a vendor or fulfillment provider (e.g., store, online store, warehouse, E-commerce platform). That is, the item is described in terms of a sales description. For example, the component “1 small salmon filet” might be described as “salmon filet—10 oz.” Shopping item description 404 can include other types of information such as an item image 408 and an item text description 407. A brand selection drop-down 420 may also be provided in this column, or in another suitable column. Brand selection drop-down 420 enables a user to select from among a plurality of brands of the shopping item corresponding to the particular component. For example, in the citrus-Dijon wild salmon recipe example, the recipe calls for orange juice. If multiple brands of orange juice are available on the vendor side of the ordering process, those multiple brands may be presented to the user, and the user may select from among those presented.

Order box 405 includes information related to ordering a particular shopping item and may also include selection mechanisms for a user to adjust an order. For example, order box 405 may include a quantity selector 409. Order box 405 may also include a cost-per-unit indicator 410 and a total-cost indicator 411. Order box 405 may be configured to allow a user to select a quantity, display the cost per unit of the respective item, automatically calculate the total cost for the number of items selected by the user, and display the total cost. Order box 405 may also include a confirmation button 412, which allows a user to confirm placement of an order for the item(s) selected. Confirmation may occur in any suitable way. In at least some embodiments, confirmation includes electronically placing the confirmed item(s) in a user's electronic shopping cart.

Display 401 may also include a cost add-on box 413, which indicates additional order processing items and costs. For example, cost add-on box 413 may include a subtotal sub-box 414, which indicates the subtotal of the items selected and confirmed by the user, but before, shipping, tax, and other processing costs are factored in. A shipping sub-box 415 may also be included to allow the user to select from a variety of shipping methods and to indicate the cost of the shipping method selected. A tax sub-box 416 may be provided to calculate and display taxes for the purchased items. A grand-total sub-box 417 may be provided to calculate and display a grand total for the order.

Display 401 may also include a checkout initiation button 421, which enables a user to initiate a checkout and payment process. Activation of the checkout initiation button 421 may result in a checkout popup window, or in the user being redirected to a checkout web page or some other digital space for proceeding with the checkout process. Once the order has been completed, the order information may be transmitted to one or more vendors, fulfillment platforms, E-commerce sites, and the like. In at least some embodiments these platforms are external to the system and operated by third parties. Software and hardware may be provided at these sites to receive and process the order and complete fulfillment of the order. The is process may be accomplished, for example, by way of APIs (Application Programming Interfaces) that establish the ability for the system to communicate and interact with the supplier platform(s). Other configurations and architectures may be incorporated in the alternative.

FIG. 5 illustrates a scheduling matrix web page, which enables a user to establish a delivery or pick-up time. Scheduling display 501 includes a scheduling matrix 502, having rows and columns for dates and times. In one example, the various columns represent days and dates such as day/date 503, while the rows 504 indicate various times or time ranges. Scroll bars (not expressly shown) may be provided to scroll to additional days, dates, times, time ranges, etc. An order processing button 505 enables a user to confirm the order and initiate the fulfillment and delivery process. Delivery may mean direct delivery to the user's location or to a specified location. Delivery may also mean delivery to one or more stores for user pick-up. Delivery may also mean simply mean that a store that is acting as the supplier collects the information, fulfills the order, and makes the order available to the user at the store.

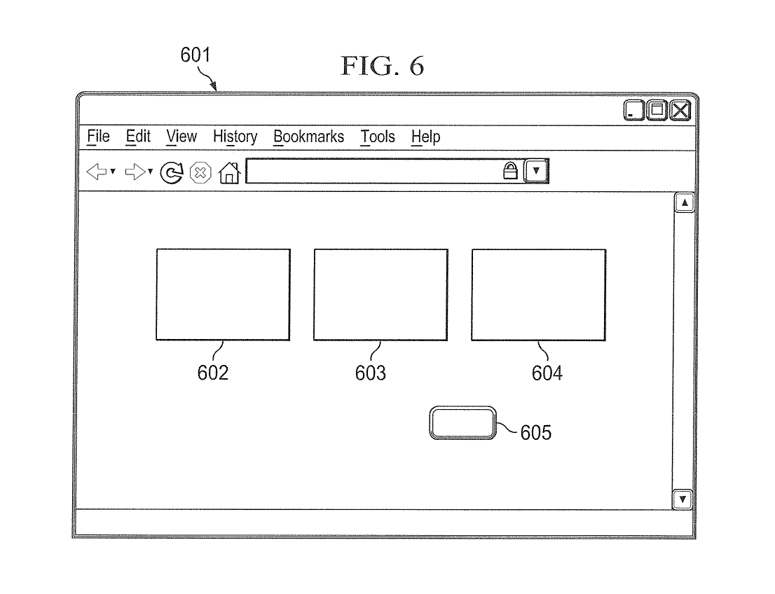

FIG. 6 illustrates an order processing web page, which enables a user to complete further processing steps and provide the system, or a supplier, with additional information concerning billing, delivery address, and payment. Order processing display 601 may include a billing information box 602, in which a user may provide billing information such as a billing address and zip code, for example. Display 601 may also include a shipping information box 603, which enables a user to provide shipping information such as a delivery address, for example. Display 601 may also include a payment information box 604, which enables a user to enter payment information, such as credit card information, for example. Other boxes may be provided here, or on other pages, to enable users to provide other relevant information such as usernames, passwords, registration information, and the like. A confirmation button 605 enables a user to confirm and complete the order, delivery set-up, payment, and any other suitable and/or necessary steps for ordering items.

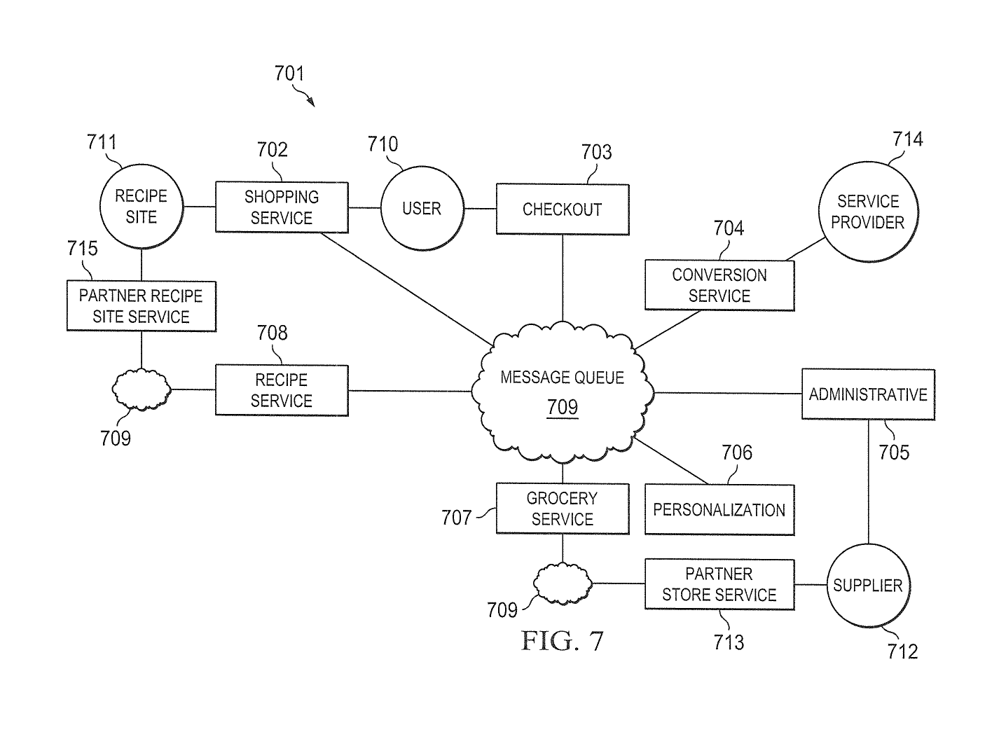

FIG. 7 illustrates an example architecture for providing the functionality described herein. This is an example only and variations may be made to the illustrated architecture as appropriate. Other alternative architectures may be incorporated. As illustrated, system architecture 701 includes a variety of platforms and components that may be used to realize the functionality described herein. Architecture 701 includes a shopping service platform 702, a checkout platform 703, a conversion platform 704, an administrative platform 705, a personalization platform 706, a grocery service platform 707, and a recipe service platform 708. All of these platforms may be in electronic communication with one another through any suitable network. As illustrated, the various platforms are connected to a message queue 709, which enables message back and forth between platforms. It should be understood that the various platforms may be in separate computing platforms. Alternatively, one or more platforms may be combined in one or more other platforms. Also, the functionality of a given platform may be divided into one or more additional platforms. In one example, the functionality of one or more platforms of the architecture is provided in the one or more modules 105, or other system components, of the system illustrated in FIG. 1.

Recipe service platform 708 for example, may provide the recipe presentation functionality described herein. Shopping service platform 702 may provide functionality associated with creating and managing shopping lists (e.g., grocery lists), the filling of a user's electronic shopping cart, and the other associated and alternative functionality described herein. Checkout platform 703 may enable user, order processing, payment processing, billing, and checkout processes, as well as other associated and alternative functionality described herein. Conversion service platform 704 may operate, for example, in conjunction with other platforms such as recipe service platform 708 and shopping service platform 702 to convert component listings (e.g., recipe listings) into shopping item lists (e.g., grocery lists) and to calculate amounts needed for various components, associated costs, unit conversions, and the like. Administrative platform 705 provides administrative functionality such as, for example, order notifications, user preference settings, and the like. Personalization platform 706 provides personalization functionality such as that associated with targeted and/or location-based advertising, custom user recommendation services, and the like. Grocery service platform 707 provides functionality associated with managing metadata, inventory data, and the like, especially that associated with suppliers and other third party platforms.

One or more partner recipe site services 715 may be provided to provide, for example, recipe-specific back-end communication. Partner recipe site service 715 may be in communication with one or more users 710 through one or more corresponding recipe sites 711. The one or more users may also be in communication with other architecture components, such as, for example, shopping service platform 702 and checkout platform 703. One or more order management service providers 714 may also be included to supply and/or be in communication with conversion service platform 704. One or more suppliers 712 may also be included to provide functionality for and/or be in communication with administrative platform 705. The one or more suppliers 712 may also be in communication with and/or provide functionality for one or more partner store service platforms 713, which provide, among other things, supplier-specific communication.

FIG. 7 is illustrated in the context of food, recipes, and the like. However, it should be understood that a similar architecture may provide the same functionality in the context of other industries, domains, subjects, etc. For example, the same or similar architecture may be used to provide home improvement component listing and order processes, activity gear list management, travel itinerary creation and booking services, and the like.

In at least some embodiments, the architecture is a service-oriented architecture (SOA) that promotes interoperability and scalability between well-defined autonomous services. The architecture is adaptable to changing conditions (e.g., changing inventory catalog and supply availability, new recipe sites and recipes, new grocery store physical locations, new discount coupons from brand manufacturers, new shopping front-end functionality, support for mobile applications, social-network integration, and so forth).

In certain embodiments, the architecture may be programming language-agnostic. In other instances, languages such as Ruby and Rails or alternatively Python and Django may be incorporated for most services. The Java Virtual Machine (JVM) may be employed for machine learning/natural language processing tasks. The conversion service may, for example, use Ruby, Scala, or Clojure to drive the JVM.

The architecture may use a grocery service that allows communication with grocery stores. The database to build the supermarket service may be obtained from vendor platforms, for example.

In at least some cases, the shopping service is adapted to manage customer carts and accounts, and to allow customers to search for, categorically browse, and add grocery items to a cart. In at least some cases, the checkout service is adapted to enable checkout and payment processing, and order routing. In at least some cases, the conversion service is adapted to enable the conversion of recipe items to grocery items, conversion of measurement units (e.g., converting a recipe amount or unit into a shopping list or grocery item amount or unit so that there is an appropriate amount of the proper ingredient for a certain recipe), and parsing recipe ingredients. In at least some cases, the recipe service is adapted to manage recipes. In at least some cases, a grocery service is adapted to manage supplier meta-data (e.g., name, location, store hours, etc.), and manage inventory data. In at least some cases, a grocery partner service is adapted to manage communication with grocery partners' systems.

In at least some embodiments, a queue-based asynchronous communication protocol is established between architecture services and/or corresponding system components. For instance, the conversion service may comprise a simple application with a small database of human-specified conversions of recipe partners' content into grocery partners' inventory items.

According to other aspects, the architecture enables users to browse recipe site partners, add recipes to a shopping cart, add additional “cooking staple” items to the cart, and complete checkout. Integration with a recipe website, in at least some embodiments, is accomplished with a single one line of js code. All that is required is for the recipe partner to place a system “Buy Ingredients” button on a select number of recipe pages. Prior to the functionality being activated, each recipe is processed by parsing and adding it to a recipe service database, and running a manual hardwire conversion to produce the conversion into grocery store items and quantities, and store the results in a conversion service database. Partner recipe websites may agree to display the “Buy Ingredients” button next to the top N-thousand recipes by views and embed JavaScript callbacks to support button operation. Partner sites may attach, link, or otherwise connect one or more of their recipes (or component items lists) to “Buy Ingredients” button or tab (or other indicator), which may represent embedded code. A recipe page containing the button may load an MVC-type, modern JS framework such as ember.js (or backbone.js or similar) on the client's browser on the first user click. Clicking the “Buy Ingredients” button will make a RESTful API request to a shopping service system component with a recipe-unique ID and a system browser cookie to help identify the customer and session. If the user is a first-time user, the IP of the client may be sent instead and a cookie may be set to initiate a session.

Integration with a grocery store can vary greatly in complexity and therefore time-to-implement and cost. Complexity depends directly on the level of IT maturity and sophistication of the partner store. In some cases, the partner may enable direct access to their centralized and real-time or quasi-real-time inventory APIs or databases. Integration may involve a periodic HTTP upload to cloud storage such as Amazon's S3, EDI messaging over a private network, or an alternate configuration or protocol. Communication and synchronization may be implemented in a custom service which communicates via a message queue with the grocery service, which acts as an aggregator of all grocery services, in essence creating a global catalog of grocery items by particular locations.

If partner suppliers inventory exists in the system database(s), a hard-wired conversion may be set up that will display an individual recipe and a searchable list of inventory items, and create a shopping list/cart by matching each ingredient in the recipe to one (or more) inventory items, specifying quantities. As mentioned, the result of this conversion may be stored in the conversion service database.

The conversion service, in at least some examples, is adapted to parse recipe lines to extract ingredients and their amounts, match recipe ingredients to grocery store inventory items, and convert recipe units into grocery store units. Some of this functionality may initially be based on hard-wired conversion to create detailed shopping lists/carts from recipes. Human-generated shopping lists may be stored in the conversion service database. The conversions may serve to drive the user experience, and also serve to train machine learning algorithms to enable reproduction of conversions automatically without human intervention.

According to additional aspects, a more sophisticated means of notifying supermarkets, as well as allowing supermarkets to perform a basic set of preferences management on their system account, may be provided. The administrative service may provide this functionality and may provide a real-time dashboard to supermarket partners so that they may receive order notifications and details, view usage statistics (e.g., most popular customer selections, most substituted items, etc.), and manage basic account details and preferences.

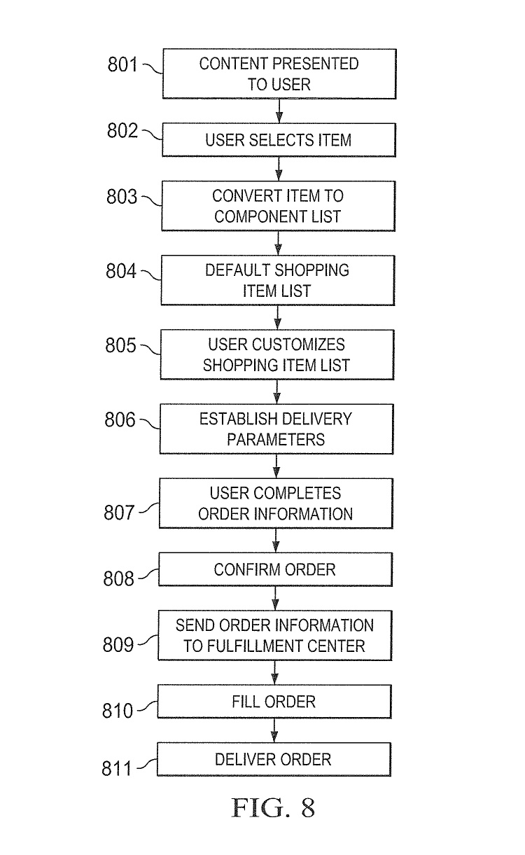

FIG. 8 illustrates a method of the operation of at least some functionality according one example embodiment. In a first step 801, content is presented to a user. In a next step 802, the user selects an item from the content. In a next step 803, the system converts the selected item into a component listing. In a next step 804, the component listing is converted into a default shopping item listing. In a next step 805, the user customizes the shopping item listing. In a next step 806, the user establishes delivery parameters. In a next step 807, the user completes ordering information, such as, for example, billing and shipping address information and payment information. In a next step 808, the user confirms the order. In a next step 809, the order information is sent to a fulfillment center. In a next step 810, the fulfillment center fills the order. In a next step 811, the order is delivered to the user.

The method illustrated is an example only. Steps may be added or deleted, and/or performed in different orders. Sub-steps may be added as well. The method may be modified in any suitable way to achieve any of the functionality described elsewhere herein. For example, step 803 involves converting a selected item (e.g., a food dish or recipe presented in website content) into a component listing (e.g., a recipe). This step may include sub-steps for activating a link, querying a database for stored component listings, making comparisons between stored listings and the presented content, and the like.

In another example method a user chooses a recipe and is shown a button to “Buy Ingredients” located next to the list of recipe ingredients. The user clicks “Buy Ingredients” and adds ingredients from the recipe to a cart (e.g., via a popup window overlaying the recipe website). The user has the option to deselect unneeded items. The user has the option to purchase additional common “cooking staples.” The user may also have the option to choose from among different brands of shopping items and/or from among different suppliers. The user can select “Continue Recipe Search” or “Checkout.” The user eventually selects “Checkout” and indicates a delivery date/time window. The user inputs payment information and delivery address information. The order is routed to a grocer with accompanying payment. A confirmation email may be sent to the user. The order is fulfilled (e.g., next day delivery or in-store pickup).

Referring again to FIG. 1, at least some embodiments are directed to the recognition and conversion of media content (e.g., including unstructured web content). One or more modules 105 may include software to achieve this functionality. Alternatively, this functionality may be provided elsewhere in the platform, elsewhere in the system, or externally to the system.

In at least some embodiments, recognition involves recognizing those situations in which a subject is presented with a description of component parts. Recognition of appropriate content may be accomplished in any suitable manner. In one example alternative, recognition involves identification of one or more key words or phrases (e.g., recipe, items, components, parts, cooking, oven, broil, etc.). Recognition might further involve analyzing surrounding content for additional words, symbols, images, other content relevant to the subject or domain and/or relationships between these indicators (e.g., proximity, frequency of use, and the like). In another alternative, recognition involves determining proximity of key words (or phrases, symbols, images, etc.). For example, if “boil” occurs within five words of “minutes,” this might be an indicator that the content concerns a recipe. In another alternative, recognition involves spatial analysis of items (words, images, etc.) within the content. In another alternative, recognition involves comparing content items (e.g., text, images, etc.) to stored items. For example an identified paragraph of text within content might be compared to a database of recipes. Based on any number of suitable criteria, the system may determine whether the comparison results in a match. For instance, if the comparison between a content paragraph and a stored recipe resulted in a certain percentage match of key terms, then a match might be indicated. One or more closest matches might be determined by the same or similar methods. In another alternative, recognition involves identification of spatial boundaries within the media platform. For instance, certain positions or areas on a screen or display might indicate that the content at that position, or within that area, is related to particular subject (e.g., a food dish). Sounds may be also be used for recognition. User indications may also be used for recognition (e.g., a user using a snipping tool to identify a recipe). In other alternatives, recognition involves the identification of certain data (e.g., flags, metadata, indicators, links, and the like). In any of these examples, an initial recognition might trigger a secondary recognition process. For example, an initial recognition may trigger access to a database. The database may have one or more component listings for alternate configurations of the selected subject (e.g, multiple recipes for a selected food dish). The system may be further operable to determine a match ranking of comparisons between stored items and items collected from content.

Reading and conversion involves determining what the content says and converting it into a format that can be used by the system to provide the functionality described herein. Any appropriate tools may be utilized for converting the media content into usable data for the system. This may involve techniques such optical character recognition and the like. Conversion may involve employing one or more tools or algorithms to convert unstructured data into structured data (e.g., structured data that is usable by the system to provide the described functionality). This may involve such techniques as data refinement, flash data reading, parsing, data scraping, and image to text conversion, for example. In at least one alternative, a selected component listing is compared to a database of component listings to determine a closest match. Once the system presents a user with a subject, component listing, or some other item or dataset, then the user may manipulate the data (e.g., add or remove items from a presented recipe). In at least one embodiment a link may redirect a user to a subject description and/or component listing corresponding to the content, but usable by the system for providing the functionality described herein. For example, content showing a food recipe might have the word “recipe” linked to a recipe in a format that may be manipulated by the user as described elsewhere herein.

Other aspects may be incorporated into one or more embodiments. In certain cases, the system converts unstructured web content (e.g., recipes or images of food items) into E-commerce orders. This enables users, who search for recipes for example, the ability to buy ingredients directly on sites with food themed content. The system (or its platform, or modules or software within the platform, or through any other suitable system component) identifies ingredient “mentions” within a web-based corpus or domain (e.g., recipe websites/blogs) and disambiguates the “mentions” against food product offerings (e.g., grocer catalogs). The system may convert recipe ingredients into, for example, food suppliers' SKUs and online orders by crawling the web and applying machine learning algorithms to match food supplier catalogs with consumer demand on a geo-location basis.

According to another aspect of at least some embodiments, content, sales, offers, and the like may be pushed to users based on predetermined criteria. The criteria may be related to actions taken by the user. For example, clicking on a subject, choosing certain shopping items, picking certain brands, and the like, all represent actions by a user that involve the functionality described herein. In response to a certain action (or not in response to the action, but based on the action), the system may push information to a user, route information, redirect a user to information, and so forth. In one specific example, software in the system receives, as input, one or more particular shopping items selected by the user, the volume or size of the shopping item(s), and a comparison of the shopping item(s) size to the require amount of the corresponding recipe ingredient. Based on these criteria, the system may push a secondary recipe to the user and notify the user that because the user is already purchasing a certain amount of the respective shopping item(s), the user may consider the secondary recipe since making the secondary recipe will only require a certain number of additional components (the number of additional components being less than the total number of components for the recipe had the user started with the secondary recipe). Other information that may be pushed or otherwise delivered includes offers for related items such as cookware, tools, appliances, services, and the like. Other information may be non-related information and offers, but directed to the user based on, for example, demographic conclusions drawn from the user's actions.

It should be understood that other aspects of the invention and other embodiments will be apparent to those having ordinary skill in the art. Certain other embodiments or variations to embodiments described herein are considered to be a part of the disclosure. Modifications may be made to the systems and components described herein. For example, although various software modules are described as residing on various system components, the software modules and functionality may reside on different components than as described and in different combinations than as described. Additionally various modules may be combined and various software functionality may be provided in different combinations than as described.

1. A fulfillment system, comprising:
an object recognition module adapted to recognize an object within content on a media display;
a component set creation module adapted to convert the object into a component set of one or more components of the object;
a conversion module adapted to convert the component set into an order request for ordering the one or more components of the component set, the order request having one or more order items corresponding to one or more of the one or more components of the component set; and
a supplier matching module adapted to match the order for matching the one or more order items of the order request with a supply source having at least one of the one or more order items.

2. The fulfillment system of claim 1, further comprising a delivery module adapted to establish delivery parameters for the at least one of the one or more order items.

3. The fulfillment system of claim 1, wherein the component set creation module is further adapted to read the content to determine the one or more components.

4. The fulfillment system of claim 1, wherein the component set creation module receives the one or more components from a database.

5. The fulfillment system of claim 1, wherein the order request is established as a default order request adapted to be modified by the user.

6. The fulfillment system of claim 1, wherein the user may modify the order request.

7. The fulfillment system of claim 1, wherein the object recognition module is adapted to read media content to determine one or more content items having a predetermined relationship to the object.

8. The fulfillment system of claim 1, wherein the component set creation module is further adapted to indicate components as belonging to one or more subsets based on type of component.

9. The fulfillment system of claim 1, wherein the component set creation module is further adapted to indicate one or more components as staple components and one or more components as non-staple components.

10. The fulfillment system of claim 1, wherein the order request indicates one or more order items as belonging to one or more subsets based on type of order item.

11. The fulfillment system of claim 1, wherein the order request indicates one or more order items as staple order items and one or more order items as non-staple order items.

12. The fulfillment system of claim 1, further comprising an ontology module adapted to present a user with one or more secondary item lists, the content of the one or more secondary item lists being based on a predetermined relationship with the object.

13. The fulfillment system of claim 1, further comprising an information presentation module adapted to present information to the user based on one or more actions taken by the user.

14. The fulfillment system of claim 13, wherein the one or more actions comprises selecting an order item.

15. The fulfillment system of claim 13, wherein the one or more actions comprises selecting an order item and the information presentation module, in response to the user's selection, notifies the user of a secondary object requiring at least some of the selected order item.

16. A culinary management system, comprising:
a host platform adapted to be connected to one or more user stations and operable to send and receive electronic information, the host platform comprising one or more computers operable to execute one or more software modules, the host platform further comprising one or more databases electronically connected to the one or more computers,
wherein a first software module is operable to receive a user's selection of one or more recipes from among a plurality of recipes presented to the user; and
wherein a second software module is operable to transform information associated with the selected one or more recipes into a shopping list comprising one or more ingredients of the one or more selected recipes.

17. The culinary management system of claim 16, wherein a third software module is operable to receive input from the user to modify the shopping list.

18. The culinary management system of claim 16, wherein a third software module is operable to receive input from the user to complete an order request to obtain the one or more ingredients on the shopping list.

19. The culinary management system of claim 16, wherein a third software module is operable to interface with at least one supplier platform to determine whether the at least one supplier is capable of supplying at least one of the one or more ingredients.

20. The culinary management system of claim 16, wherein the second software module is further operable to group the one or more ingredients into one or more groups based on one or more predetermined parameters.

21. The culinary management system of claim 20, wherein the one or more parameters includes the parameter of whether the respective ingredient is a staple or non-staple item.

22. The culinary management system of claim 16, wherein a third software module is operable to determine information to present to the user based on a predetermined association between the information and the one or more recipes.

23. The culinary management system of claim 22, wherein the information presented to the user relates to tableware, and the predetermined association is tableware for a meal using the one or more recipes.

24. The culinary management system of claim 22, wherein the information presented to the user relates to additional recipes, and the predetermined association is additional recipes for food items appropriate to serve with a food item made using the one or more recipes.

25. The culinary management system of claim 22, wherein the information presented to the user relates to a suggested dining environment, and the predetermined association is dining environments for a meal using the one or more recipes.

26. A method of generating an order from media content, the method comprising:
identifying the media content;
identifying an object within the media content;
converting the object into a component list of components of the object; and
generating a shopping items list having at least one shopping item corresponding to at least one component of the component list.

27. The method of claim 26, further comprising the step of matching the shopping items list to information from at least one fulfillment platform to determine whether a vendor is able to supply at least one item on the shopping items list.

28. The method of claim 26, wherein the converting step comprises reading the media to determine the components of the component list.

29. The method of claim 26, wherein the converting step comprises comparing the object to stored information to determine a component list corresponding to the object.
